(19) United States
(12) Patent Application Publication
(10) Pub. No.: US 2006/0161424 A1
(43) Pub. Date: Jul. 20, 2006

(54) Digital multi-tone audio-sensing controller

(76) Inventor: Jiun-Chau Tzeng, Taipei City (TW)

Correspondence Address: HDSL, 4331 STEVENS BATTLE LANE, FAIRFAX, VA, 22033, US

(21) Appl. No.: 11/244,200

(22) Filed: Oct. 6, 2005

(30) Foreign Application Priority Data
Jan. 18, 2005 (TW) 094200901

(51) Int. Cl. G10L 11/00

(52) U.S. Cl. 704/200

(57) ABSTRACT

A digital multi-tone audio-sensing controller includes an audio receiver, a signal processor, a driver and a load. The audio receiver receives and outputs an external analog signal and the external analog signal are subject to amplification, frequency-division and digitalization by the signal processor for generating an external digital signal. The driver electrically outputs a driving signal based on the external digital signal. Therefore, multiple loads can be driven in programmable and flexible way.

### BACKGROUND OF THE INVENTION

1. Field of the Invention

The present invention, relates to a digital multi-tone audio-sensing controller, more particularly relates to a digital multi-tone audio-sensing controller capable of controlling multiple loads in programmable or dynamical manner by sensing the external audio signal.

2. Description of Related Art

The electrical equipment controlled by electronic signals generally relies on automatic control, manual control or audio control. More particularly, the audio control approach converts a vibration of an audio source to an audio signal and the audio signal is used for object control. The audio control approach generally uses external audio source or internal audio source for generating audio signal. The audio control approach often uses for lighting control, toy movement such as turning around for a predetermined time.

The conventional audio control approach is generally limited to turning on/off the controlled object and relates to dull movement. It cannot provide dynamic movement in response to frequency variation or intensity variation of music signal. It is desirable to provide an audio control approach to dynamically control lamp or motor in response to music tone or music frequency to provide lightening, extinguish, or twinkle effect, or motor rotation effect.

FIG. 6 shows a block diagram of a conventional multi functional lamp control apparatus, which comprises a current adjuster 4, a load 5, an operation processor 11, an optical coupler 12, an audio receiver 21, a first sensitivity adjuster 23, a music memory 31 and a second sensitivity adjuster 33.

The audio receiver 21 receives an external analog signal, and the external analog signal is processed by the first sensitivity adjuster 23 and then output to the optical coupler 12 and the load 5. The first sensitivity adjuster 23 adjusts the sensitivity for each load 5.

The music memory 31 can be realized by a music IC, which broadcasts pre-stored music through a loudspeaker 32 and produces audio signal for driving the load 5. The pre-stored music output by the music memory 31 is further adjusted by a second sensitivity adjuster 33 and then output to the optical coupler 12 and the load 5. The second sensitivity adjuster 33 adjusts the sensitivity for each of the loads 5 simultaneously.

The current adjuster 4 is electrically connected to the operation processor 11, thus enhancing the sensitivity for external analog signal. The operation processor 11 switches control signals.

As mentioned above, the load 5 is driven by analog signal, multiple loads can not be controlled in programmable or dynamical manner by sensing the external audio signal. Moreover, it cannot perform frequency division processing to the external audio signal, the load cannot have flexible actions regarding to different frequencies.

### SUMMARY OF THE INVENTION

The present invention is to provide a digital multi-tone audio-sensing controller performing amplification and frequency-division to a received analog signal and outputting a digital signal instead of an analog signal. Therefore, the digital multi-tone audio-sensing controller controls multiple loads in programmable or dynamical manner by sensing the external audio signal

Accordingly, the present invention provides a digital multi-tone audio-sensing controller includes an audio receiver, a signal processor, a driver and a load. The audio receiver receives and outputs an external analog signal and the external analog signal are subject to amplification, frequency-division and digitalization by the signal processor for generating an external digital signal. The driver electrically outputs a driving signal based on the external digital signal. Therefore, multiple loads can be driven in programmable and flexible way.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a block diagram of the digital multi-tone audio-sensing controller according to a preferred embodiment of the present invention.

FIG. 2 shows a flow chart of the digital multi-tone audio-sensing controller according to a preferred embodiment of the present invention.

FIG. 3 shows a circuit diagram of the digital multi-tone audio-sensing controller according to a preferred embodiment of the present invention.

FIG. 4 shows another circuit diagram of the digital multi-tone audio-sensing controller according to a preferred embodiment of the present invention.

FIG. 5 shows a circuit diagram of the digital multi-tone audio-sensing controller according to another preferred embodiment of the present invention.

FIG. 6 shows a block diagram of a conventional multi functional lamp control apparatus.

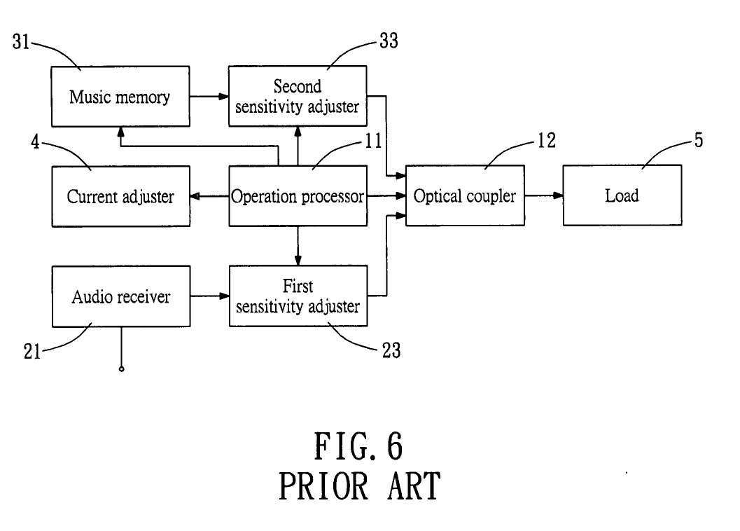

### DETAILED DESCRIPTION OF THE INVENTION

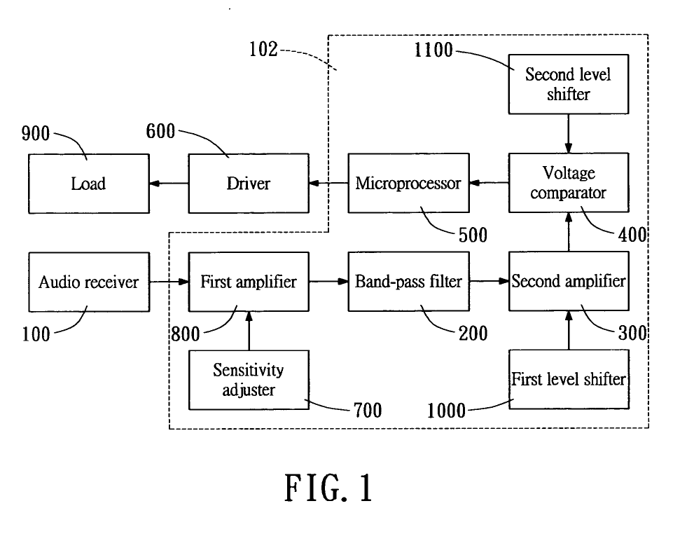

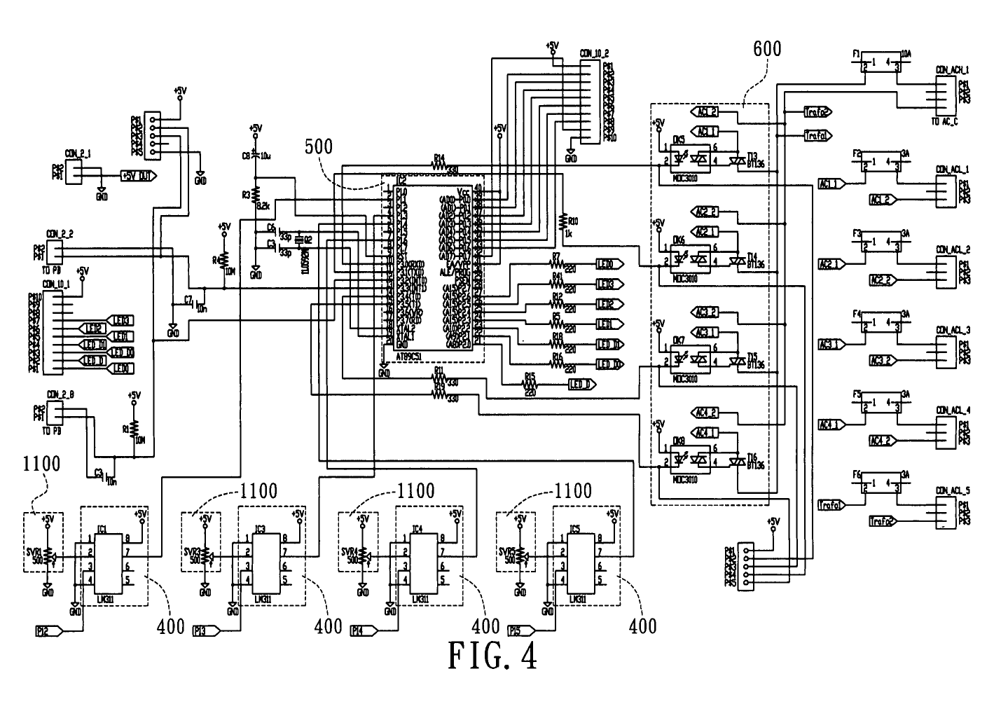

FIGS. 1, 3, 4 show a preferred embodiment of the present invention, wherein a light emitting element or a motor is used as load. The digital multi-tone audio-sensing controller according to the preferred embodiment of the present invention digitally drives multiple loads according to various frequencies and intensities of audio signal. Alternatively, the loads are driven by outputs of processor. The digital multi-tone audio-sensing controller according to the preferred embodiment of the present invention provides audio-controlling function.

According to the preferred embodiment of the present invention, the audio receiver 100 receives and outputs an external analog signal. The signal processor 102 is electrically connected to the audio receiver 100 and adapted for amplifying and frequency-dividing the analog signal. The signal processor 102 further digitizes the analog signal for generating a digital signal.

The signal processor 102 comprises a first amplifier 800, a sensitivity adjuster 700, a band-pass filter 200, a second amplifier 300, a voltage comparator 400, a first level shifter 1000, a second level shifter 1100 and a microprocessor 500.

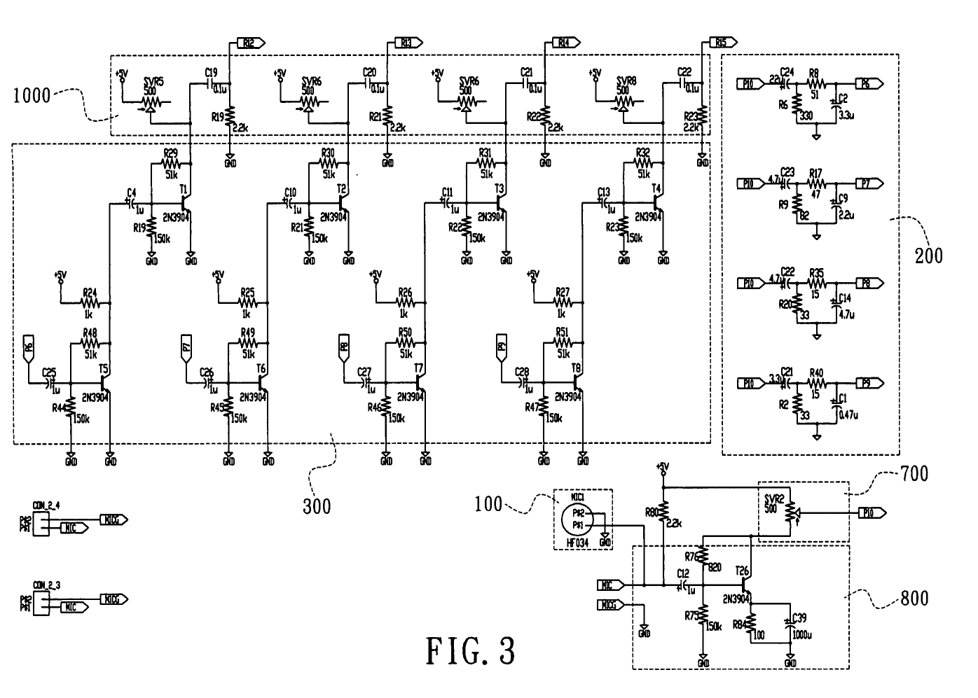

The first amplifier 800 is electrically connected to the audio receiver 100 and the sensitivity adjuster 700 and amplifies the signal received from the audio receiver 100 before outputting the signal. As shown in FIG. 3, the sensitivity adjuster 700 can be implemented by a potentiometer and is electrically connected to the first amplifier 800. The sensitivity adjuster 700 performs sensitivity adjustment for the signal received by the first amplifier 800.

The band-pass filter 200 is electrically connected to the first amplifier 800 and performs filtering and frequency-division to analog signals, which have been amplified and sensitivity-adjusted.

The second amplifier 300 is electrically connected to the band-pass filter 200 and performed second-amplification to the signals, which are already filtered and frequency-divided. The voltage comparator 400 is electrically connected to the band-pass filter 200 and compares the amplified signal with a reference voltage for outputting a digital signal. The first level shifter 1000 is electrically connected to the second amplifier 300 and adjusts the signal level for the amplified signal from the second amplifier 300. The second level shifter 1100 is electrically connected to the voltage comparator 400 for adjusting the reference voltage for the voltage comparator 400. The microprocessor 500 is electrically connected to the voltage comparator 400 and a driver 600, and further processes the digital signals sent from the voltage comparator 400.

In above-mentioned preferred embodiment, the microprocessor 500 can be implemented by MCU (micro controller unit) for advanced digital processing of digital signals, In other preferred embodiments, the microprocessor 500 can be implemented by micro-chip for performing similar functions with the microprocessor 500.

The driver 600 is electrically connected to the microprocessor 500 and sends a driving signal according to received digital signal. A load 900 is electrically connected to the driver 600 and controlled by the driving signal.

In the present invention, the microprocessor 500 can be switched to multiple modes.

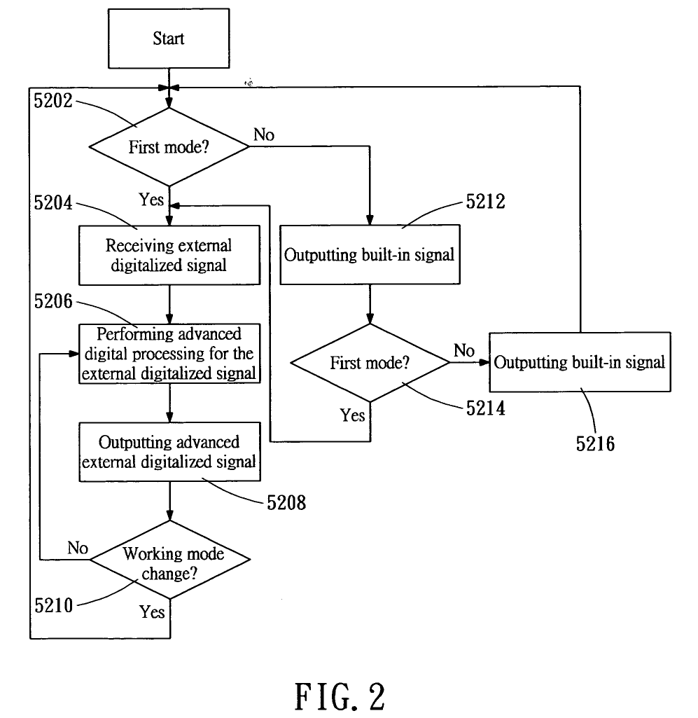

FIG. 2 shows a flowchart for operating the digital multi-tone audio-sensing controller according to a preferred embodiment of the present invention. In the following description, the first mode is the action of device according to external signal; while the second mode is the action of device according to internal signal.

In this preferred embodiment, the microprocessor 500 will keep judging whether the first mode is selected (step 5202), and the microprocessor 500 receives the digitalized external signal when the working mode of device is judged to be the first mode (step 5204).

The received digital external signals are treated by advanced digital processing and then sent to the driver 600 (step 5208). Afterward, step 5210 judges whether the working mode is changed. The procedure is back to step 5202 when the working mode is changed. Otherwise, the procedure is back to step 5206 when the working mode is not changed.

More particularly, the working mode for device can be manually switched by using the external interrupt pin of the microprocessor 500.

In step 5202, when the working mode is judged not to be the first working mode, the microprocessor 500 outputs a built-in digital signal (step 5212), and then judges whether this mode is the first working mode. When the mode is judged to be the first working mode, the built-in digital signal is not output and the procedure is back to step 5204. Otherwise, the built-in digital signal is output when the mode is judged not to be the first working mode (step 5216).

Moreover, the audio receiver 100 can be any sound-collecting element such as microphone.

Moreover, the load 900 can be anyone of, but not limited to, light emitting element or motor.

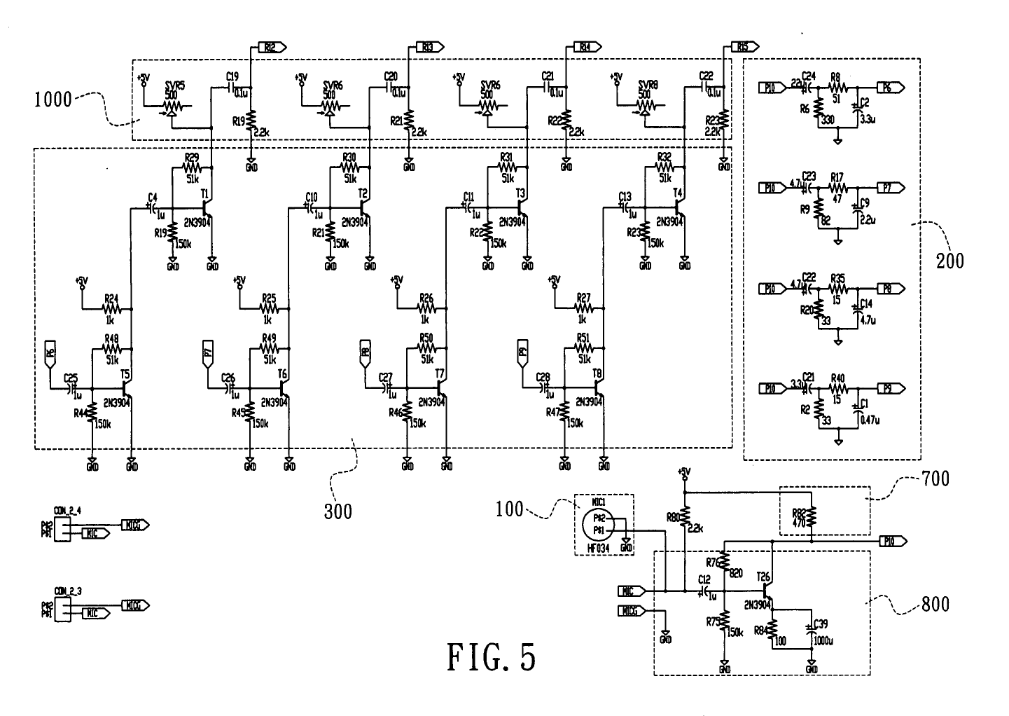

Moreover, the sensitivity adjuster 700 can be constant resistor as shown in FIG. 5 besides potentiometer.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A digital multi-tone audio-sensing controller, comprising:
an audio receiver receiving and outputting an external analog signal;
a signal processor electrically connected to the audio receiver and performing amplification, frequency-division and digitalization to the external analog signal for generating an external digital signal;
a driver electrically connected to the signal processor and outputting a driving signal based on the external digital signal; and
a load electrically connected to the driver and controlled by the driving signal.

2. The digital multi-tone audio-sensing controller as in claim 1, wherein the signal processor comprises:
a sensitivity adjuster electrically connected to a first amplifier to adjust an amplification ratio of the first amplifier to the external analog signal;
a first amplifier electrically connected to the audio receiver and the sensitivity adjuster to amplify the external analog signal;
a band-pass filter electrically connected to the first amplifier for filtering and frequency-dividing the sensitivity-adjusted and amplified external analog signal;
a second amplifier electrically connected to the band-pass filter and second-time amplifying the filtered and frequency-divided external analog signal;
a first level shifter electrically connected to the second amplifier and adjusting a signal level of the second-time amplified external analog signal;
a second level shifter electrically connected to a voltage comparator and adjusting a reference voltage level for the voltage comparator;
a voltage comparator electrically connected to the second amplifier, the second level shifter and a microprocessor, and generating an external digital signal after comparing the second-time amplified external analog signal and the reference voltage level; and
a microprocessor electrically connected to the voltage comparator and the driver, and performing an advanced digital processing for the external digital signal.

3. The digital multi-tone audio-sensing controller as in claim 2, wherein the microprocessor outputs a digital built-in signal stored therein after receiving a manual switch signal.

4. The digital multi-tone audio-sensing controller as in claim 2, wherein the microprocessor is one of MPU and micro-chip.

5. The digital multi-tone audio-sensing controller as in claim 2, wherein the band-pass filter divides received signal to signals of at least one set of frequency.

6. The digital multi-tone audio-sensing controller as in claim 2, wherein the sensitivity adjuster is fixed resistor or potentiometer.

7. The digital multi-tone audio-sensing controller as in claim 1, wherein the load is anyone of, but not limited to, light emitting element or motor.

8. The digital multi-tone audio-sensing controller as in claim 1, wherein the load is an alternative power driven device within a rated voltage or current.

9. The digital multi-tone audio-sensing controller as in claim 1, wherein the signal processor controls AC or DC load.

10. The digital multi-tone audio-sensing controller as in claim 1, wherein the digital multi-tone audio-sensed controller controls at least one independent load according to signal frequency and intensity.
